(19) United States
(12) Patent Application Publication
(10) Pub. No.: US 2025/0108447 A1
(43) Pub. Date: Apr. 3, 2025

(54) STACKABLE LOUVERS FOR ARC PROCESS DEVICES

(71) Applicant: The ESAB Group, Inc., North Bethesda, MD (US)

(72) Inventors: Jeroen Johan Dekker, Olofstorp (SE); Fredrik Stjernlöf, Torslanda (SE); Johan Johansson, Vedum (SE)

(21) Appl. No.: 18/903,023

(22) Filed: Oct. 1, 2024

Related U.S. Application Data
(60) Provisional application No. 63/587,197, filed on Oct. 2, 2023.

(51) Int. Cl. B23K 9/10

(52) U.S. Cl. CPC B23K 9/1006

(57) ABSTRACT

A louver panel for an arc plasma device. The louver panel includes several louver modules that define tortuous paths from an upstream side to a downstream side of the louvered panel, and a support member coupled to the louver modules. The tortuous paths permit flows of gas and prevent contaminants from traveling to the upstream side. A louver module includes a frame, a first fluid guide supported by the frame, and a second fluid guide extending from the first fluid guide.

### CROSS-REFERENCE TO RELATED APPLICATION

This patent application is a non-provisional application of, and claims priority to and the benefit of, U.S. Provisional Patent App. No. 63/587,197, filed Oct. 2, 2023, entitled “Stackable Louvers For Arc Process Devices,” having Attorney Docket No. 1485.1027P, the entire disclosure of which is incorporated by reference herein in its entirety.

### FIELD OF INVENTION

The present disclosure is directed toward an arc process device, such as a plasma cutting or welding device, and, in particular, to a panel of stackable louvers for allowing airflow therethrough while preventing contaminants from entering a housing a device.

### BACKGROUND

Generally, a louver is a mechanical device that allows air to flow through a machine housing for cooling purposes and prevents liquid drops or spray from getting into the housing of the machine, such as a power supply or wire feeder. Conventional louvers are designed with an array of “fins” that have a downward angle orientation. This solution allows air to flow though the openings while discouraging the entry of a liquid. Typically, the louvers are formed from a single piece of sheet metal (e.g., via stamping) or integrated in an injection molded plastic panel. However, conventional louvers may not adequately prevent liquid spray from entering a component housing because a liquid droplet or spray may bounce off a fin of the louver and into the component housing. Consequently, electrical components within the housing may be damaged.

### SUMMARY

The techniques presented herein provide a louver panel for an arc process device having a plurality of louver modules that define a tortuous path from an upstream side to a downstream side of the louvered panel. The tortuous path permits a flow of gas (e.g., air) and prevents contaminants from traveling through the louver panel.

In some aspects, the techniques described herein relate to a louver module including a frame, a first fluid guide supported by the frame; and a second fluid guide extending from the first fluid guide. The first fluid guide and the second fluid guide cooperate to form a tortuous path from a downstream end to an upstream end of the louver module.

In at least one form, the tortuous path permits a flow of gas, and impedes a flow of contaminants.

In some implementations, the first fluid guide extends from the frame at a first angle and the second fluid guide extends from the first fluid guide at a second angle. The second fluid guide is configured to horizontally overlap with a frame of an adjacent louver module, and the second fluid guide obstructs contaminants.

In some instances, the louver module further includes a wing disposed above the first fluid guide and the second fluid guide, the wing being configured to guide a gas from the second fluid guide towards the downstream end of the louver module.

In one form, the louver module further includes a coupling arrangement configured to couple the louver module to a second louver module. The coupling arrangement may be disposed on the frame and may be configured to couple to a second fluid guide of the second louver module.

In some aspects, the techniques described herein relate to a louvered panel of an arc process device including a plurality of louver modules defining a tortuous path from an upstream side to a downstream side of the louvered panel. The tortuous path permits a flow of gas and prevents contaminants from traveling to the upstream side. A support member couples to the plurality of louver modules.

In at least one form the plurality of louver modules are vertically stacked.

In some implementations, each louver module of the plurality of louver modules overlaps with at least a portion of an adjacent louver module to define the tortuous path.

In some instances, the plurality of louver modules includes a base module and a cap module. Each louver module may include a frame and a first fluid guide supported by the frame. The base module may include a second fluid guide supported by the frame and extending from the first fluid guide. The base module may further include a wing disposed above the second fluid guide. The wing may be configured to guide the flow of gas towards a downstream end of the louvered panel.

In at least one form, each frame of each louver module includes at least one coupling member configured to couple to an adjacent frame of an adjacent louver module and the support member.

In some implementations, a frame of each louver module overlaps with a second fluid guide of an adjacent louver module, and the frame of each louver module is disposed downstream of the second fluid guide of the adjacent louver module.

In some instances, the support member is a metal strip with a plurality of through-holes configured to receive a plurality of bolts. The plurality of bolts may be configured to couple the metal strip to the plurality of louver modules.

In some aspects, the techniques described herein relate to a method of blocking contaminants from entering a housing including: stacking and fastening a plurality of louver modules along a support member to form a louvered panel, the louvered panel defining a tortuous path; and fastening the louvered panel to an opening of the housing via a fastener; wherein the tortuous path prevents contaminants from entering the opening while allowing a flow of air through the louvered panel.

In some implementations, fastening the louvered panel to the opening of the housing further includes receiving, via the support member, a tab extending from a power supply base.

In some instances, the tortuous path is defined by a first fluid guide and a second fluid guide of a first louver module of the plurality of louver modules, and the second fluid guide overlaps with at least a portion of a second louver module. The second fluid guide may block contaminants from entering the opening. The portion of the second louver module may include at least a portion of a frame of the second louver module.

### BRIEF DESCRIPTION OF THE DRAWINGS

To complete the description and in order to provide for a better understanding of the techniques presented in this application, a set of drawings is provided. The drawings form an integral part of the description and illustrate an embodiment of the present application, which should not be interpreted as restricting the scope of the present application, but just as an example of how the techniques presented herein can be carried out. The drawings comprise the following figures.

FIG. 1 is a cross-sectional view of a conventional louver panel for an arc process device.

FIG. 2 is another cross-sectional view of the louver panel illustrated in FIG. 1.

FIG. 3 is a front perspective view of an arc process device, according to an example embodiment.

FIG. 4 is a partially exploded view of the front of the arc process device and louver panel illustrated in FIG. 3.

FIG. 5 is a rear view of the louver panel illustrated in FIG. 4.

FIG. 6 is a partially exploded view of the louver panel illustrated in FIG. 5.

FIG. 7 is a partially exploded bottom perspective view of the arc process device and the louver panel illustrated in FIG. 4.

FIG. 8A is a perspective view of a base louver module of the louver panel illustrated in FIG. 4.

FIG. 8B is a front view of the base louver module illustrated in FIG. 8B.

FIG. 8C is a rear view of the base louver module illustrated in FIG. 8C.

FIG. 9A is a perspective view of a cap louver module of the louver panel illustrated in FIG. 4.

FIG. 9B is a front view of the base louver module illustrated in FIG. 9A.

FIG. 9C is a rear view of the base louver module illustrated in FIG. 9A.

FIG. 10A is a perspective view of an alternative embodiment of a base louver module of the louver panel illustrated in FIG. 4.

FIG. 10B is a front view of the base louver module illustrated in FIG. 10A.

FIG. 10C is a rear view of the base louver module illustrated in FIG. 10A.

FIG. 11 is a cross-sectional view of the louver panel illustrated in FIG. 4 taken along line A-A.

FIG. 12 is a cross-sectional view of the louver panel illustrated in FIG. 4 taken along line B-B.

FIG. 13 is a cross-sectional view of the louver panel illustrated in FIG. 4 taken along line C-C.

FIG. 14 is a front perspective view of an alternative embodiment of a louver panel, which includes two alternate base louver modules.

FIG. 15 is a rear perspective view of the louver panel illustrated in FIG. 14.

Like reference numerals have been used to identify like elements throughout this disclosure.

### DETAILED DESCRIPTION

The following description is not to be taken in a limiting sense but is given solely for the purpose of describing the broad principles of the invention. Embodiments of the invention are described by way of example, with reference to the above-mentioned drawings showing elements and results according to the present invention.

Generally, the techniques presented herein are directed to a louver panel or louvered panel that includes several overlapping louver modules that allow airflow while preventing contaminants, such as liquid/water droplets, a spray, and/or debris, from entering a housing of an electrical or mechanical device. Each louver module may be an injection molded plastic part that has a geometric shape that prevents contaminants from passing through the louver panel. Each individual louver module overlaps with a portion of an adjacent louver module to create the louver panel when stacked and attached to one another. Consequently, the louver panel prevents contaminants from entering the housing (whether through a straight trajectory, parabolic trajectory, and/or in response to bouncing or ricocheting off a louver module) and allows gas and/or air to pass through the louver modules.

Additionally, the assembled louver panel can be removably mounted to an arc process device housing. In one implementation, the louver modules that collectively form the louver panel are each coupled to an adjacent louver module to form the louver panel. Then, the assembled louver panel can be coupled to the housing with fasteners. The bottom or base of the louver panel may include receiving elements that receive an engagement element extending from the arc process device to facilitate mounting the louver panel to the housing.

Each individual louver module of the louver panel may have different configurations depending on whether they are disposed at the bottom of the panel, the top of the panel, or in between the top and the bottom of the panel. Additionally, the louver modules may have cut-outs for accessing a portion of a housing of the arc process device, such as with cables, pluggable modules, and/or other accessories. The stackable louver modules can be arranged to create a customized or unique louver panel based on the requirements of the housing.

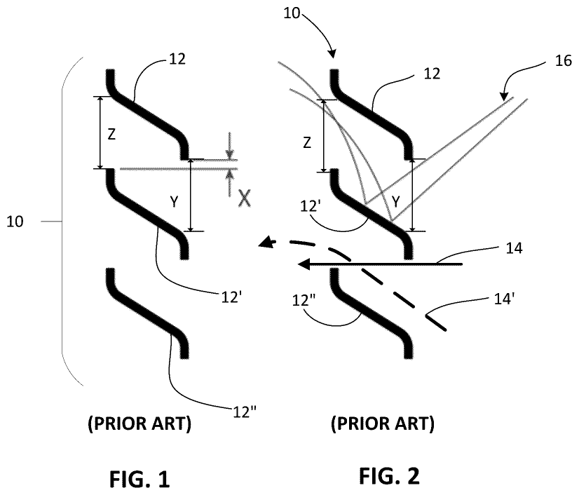

Turning to FIGS. 1 and 2, cross-sectional side views of a portion of a conventional louver panel 10 for an arc process device (such as a wire feeder, power supply, cooling unit, etc.) are illustrated. The louver panel 10 allows a gas or air to pass therethrough in both inward and outward directions. A gas can pass outwardly from, or inwardly into, a housing of an arc process device to cool the electrical and/or mechanical components located in the housing. Generally, electrical and mechanical components may be damaged in response to contact with liquids (e.g., water, oil, lubricants, etc.) and/or debris. While the conventional louver panel 10 obstructs some liquids traveling along some contaminant trajectories from entering a housing through and contacting components located therein, there are many other trajectories for contaminants that pass through the louver panel 10.

The louver panel 10 includes a plurality of slats 12, 12′, and 12″ formed from a single piece of sheet metal (e.g., via stamping) or integrated in an injection molded plastic panel. Between adjacent slats is an outlet gap Y and an inlet gap Z that allow a flow of air through the louver panel 10 of the housing of the arc process device. In both the stamped metal panel and the single-piece molded plastic panel, there are certain manufacturing restraints that prevent the slats 12, 12′, and 12″ from fully overlapping with adjacent slats in the horizontal direction, when viewed from the side. In these configurations, there is always an opening having a distance X between a lower edge of slat 12 and the upper edge of adjacent slat 12′. That is, there is a distance X where the outlet gap Y overlaps with the inlet gap Z. The size of this overlap distance X depends on manufacturing methods and other parameters, but it typically is greater than zero.

As shown in FIG. 2, the louver panel 10 defines between each pair of the slats 12, 12′, and 12″ a non-tortuous or substantially straight trajectory 14 in which a liquid, such as water, or other contaminants may pass. In addition, a liquid or other contaminants may pass along another trajectory 14′, which is different than the substantially horizontal trajectory 14. Trajectory 14′ may be substantially parallel to the slats 12, 12′, and 12″ (e.g., angled upward and toward an upstream end) before arcing downward through the inlet gap Z. Further, a spray 16 of liquid droplets or other contaminants may enter the outlet gap Y, and deflect, bounce, and/or ricochet off a slat 12, 12′ or 12″, and through the inlet gap Z. Thus, contaminants may easily bounce off the slats 12, 12′ or 12″ and pass through the louver panel 10. Consequently, the housing of the arc process device may not be adequately protected because liquid, droplets, spray, debris and/or other contaminants may easily pass through the louver panel 10 and enter the arc process device housing, thereby contaminating, corroding, and/or otherwise damaging internal components and/or the housing of the arc process device. In addition, any such liquid, droplets, spray, debris and/or other contaminants entering the housing may reach live components therein, which would make any use of the device potentially risky or dangerous.

In some conventional systems, additional layers of protection, such as screens, capture liquid and/or other contaminants that pass through the louver panel 10. However, the additional layers of protection obstruct the flow of cooling air through the panel and the housing. Consequently, cooling effectiveness of the flow of cooling air may be reduced and a load on a fan motor and/or a cooling fan driving the flow may be increased, causing excess wear.

The techniques presented herein provide a louver panel that prevents contaminants from entering an arc process device without obstructing gas flow or airflow therethrough. The contaminants may include droplets, splashes, and/or sprays of liquids (such as water, hydrocarbons, oils, lubricants, etc.) and/or debris (e.g., welding spatter, dross, flux, sand, grit, metal shards, etc.). Accordingly, the louver panels presented herein protect the electrical and mechanical components in a device housing from contaminants while providing, or permitting, improved airflow sufficient for cooling those components through the housing, as compared to conventional louver panels.

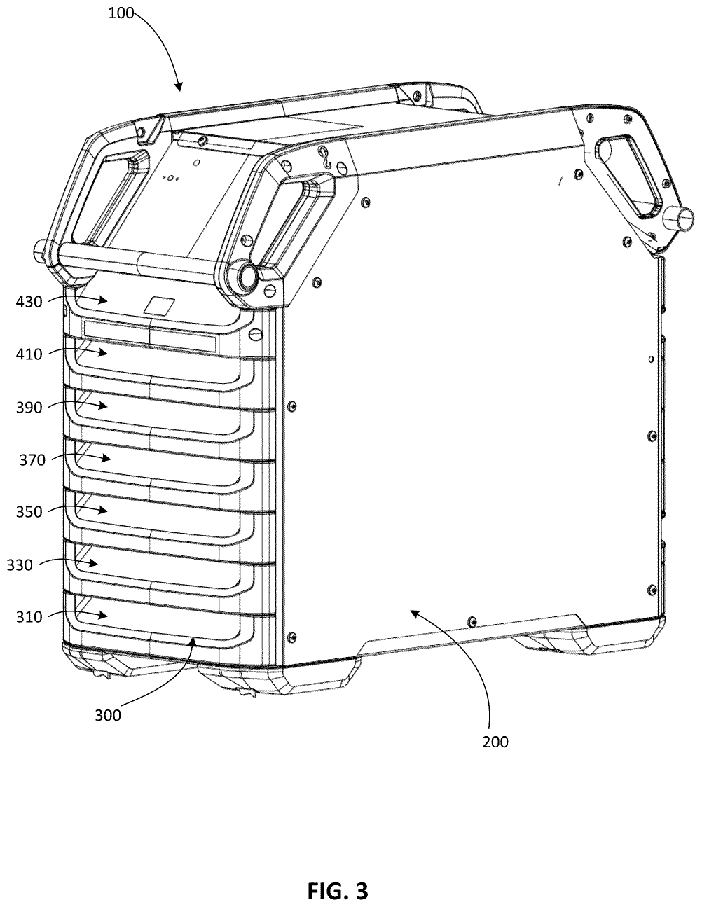

Referring to FIG. 3, a front perspective view of an arc process device 100 is illustrated. In this embodiment, the arc process device 100 is a power supply for an arc welding system, however, embodiments are not limited thereto. In other embodiments, the arc process device 100 may be any device having an inlet and/or outlet for a flow of air (e.g., a wire feeder, a cooling unit, etc.) and is exposed to contaminants. The arc process device 100 includes a housing 200 and a louver panel 300 mounted to the housing 200. The louver panel 300 includes several louver modules 310. In one embodiment, the louver panel 300 includes louver modules 310, 330, 350, 370, 390, 410, and 430.

The louver panel 300 guides a flow of air between the housing 200 and the ambient environment while impeding or preventing contaminants from entering the housing 200. That is, the louver panel 300 covers an air outlet of the housing 200 and defines a tortuous path between the ambient environment and an interior of the housing 200 to prevent contaminants from easily entering the housing 200. In some implementations, the louver panel 300 may cover an air inlet to the housing 200.

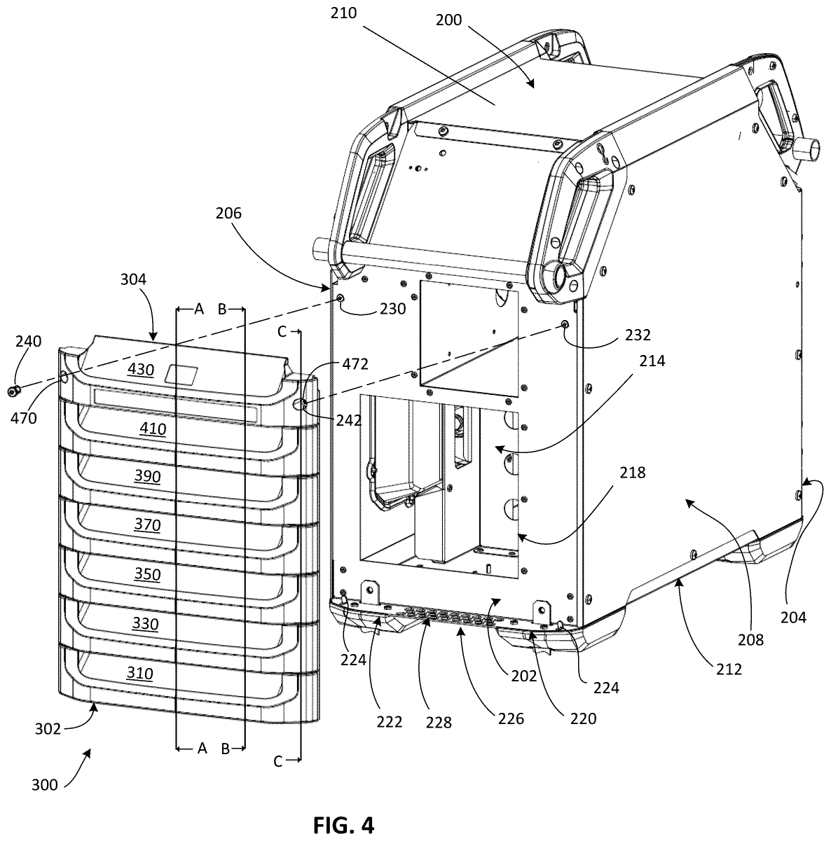

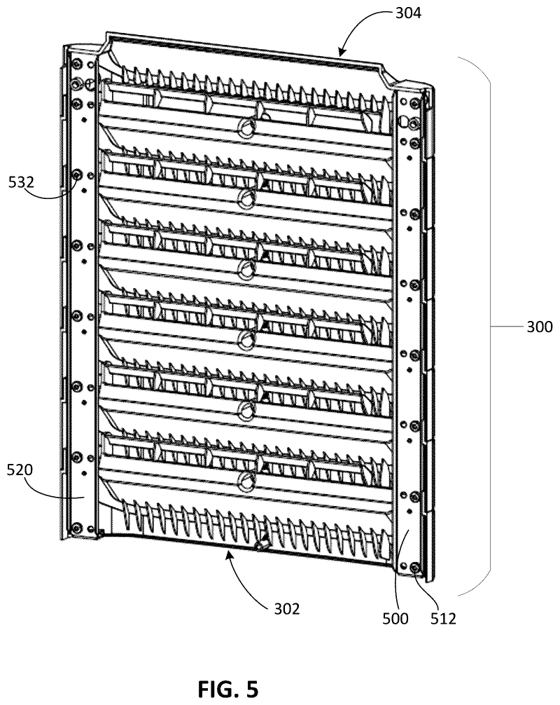

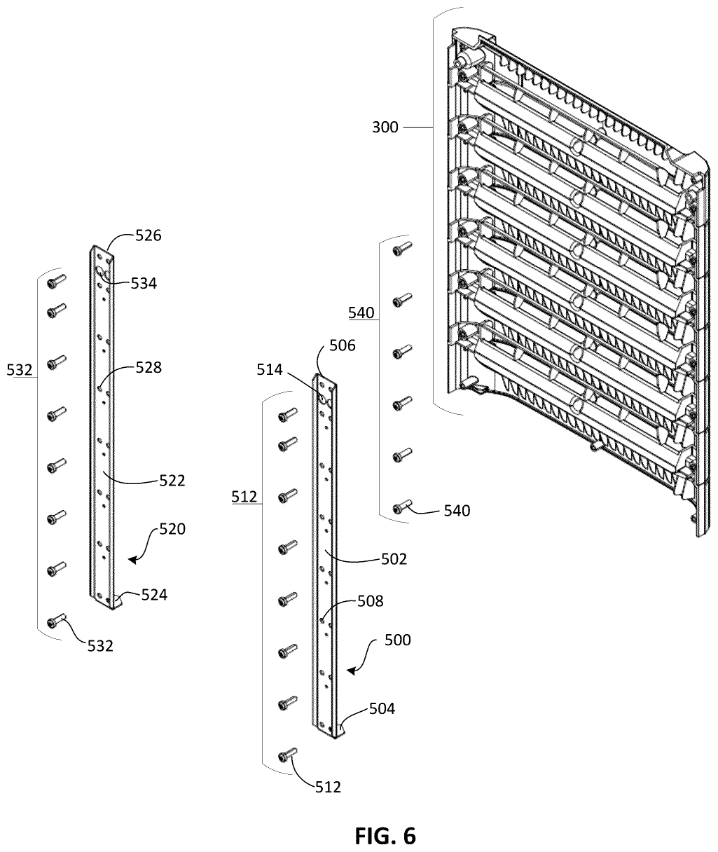

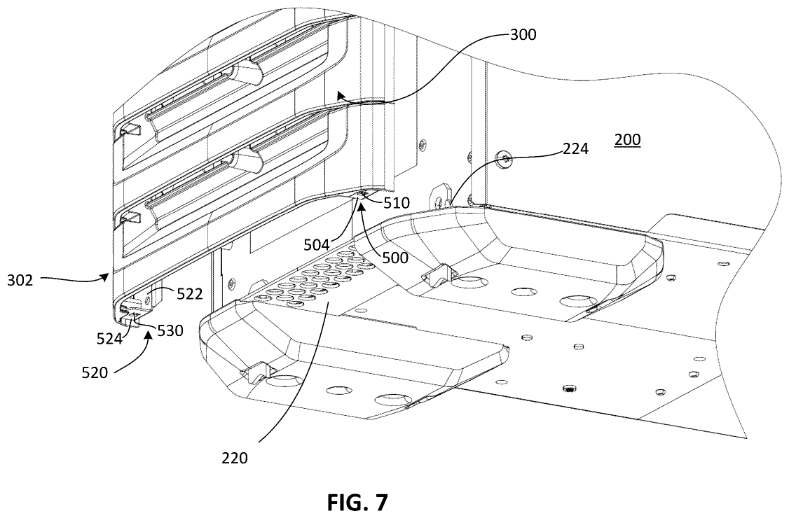

Turning to FIGS. 4-7, the louver panel 300 and the housing 200 are described. FIG. 4 is a partially exploded perspective front view of an example embodiment of an arc process device with the louver panel 300 spaced apart from the housing 200. FIGS. 5 and 6 are a rear perspective view and a partially exploded view, respectively, of the louver panel 300. FIG. 7 is a partially exploded, perspective detail view of a bottom of the housing 200 and the louver panel 300 of FIG. 4.

Referring back to FIG. 4, in this embodiment, the housing 200 includes a front end 202 and a back end 204 opposite the front end 202. Opposite lateral sides 206 and 208 extend between the front end 202 and the back end 204. The housing 200 also includes a top side 210 and a bottom side 212 opposite the top side 210. Formed in the front end 202 of the housing 200 are openings or holes 230 and 232 into which connectors are inserted, as described below.

The housing 200 also includes a mounting flange or bracket 220 extending from the front end 202. The bracket 220 supports and couples the louver panel 300 when the louver panel 300 is mounted to the housing 200. The bracket 220 has a pair of engagement portions 222, each of which includes protrusions or tabs 224, and a vent 226 that has several holes 228. The tabs 224 engage a lower portion of the louver panel 300, while the holes 228 in the vent 226 allow air to flow through the bracket 220 and into the louver panel 300.

In this embodiment, the louver panel 300 is removably couplable to the front end 202 of the housing 200. When coupled to the housing 200, the louver panel 300 covers a cavity 214 and an air outlet 218 that are formed in the front end 202 of the housing 200. The cavity 214 receives electrical components, such as one or more processors, controllers, transformers, converters, electrical circuits (e.g., voltage booster), and other components for supplying or generating an arc process current to a torch and controlling an arc processing operation (e.g., welding or plasma cutting). In one implementation, a fan (not shown) is located in the cavity 214 of the housing 200 to cool the electrical components therein. The housing 200 defines an air inlet (not shown) disposed at the back end 204. A fan may induce a flow of air into the housing 200 through the air inlet, through the cavity 214, and out through the air outlet 218 of the housing 200.

As noted above, the louver panel 300 prevents contaminants from entering the air outlet 218 while allowing air to exit the cavity 214 of the housing 200. In some implementations, the air outlet 218 may be located in the back end 204 and the air inlet may be located in the front end 202. In other implementations, one or more of the inlets and the outlets may be located in any side or surface of the housing 200, such as the front end 202, the back end 204, and the lateral sides 206 and 208). Regardless of the quantity and locations of the inlets and the outlets, a louver panel may be provided to cover each inlet and/or outlet.

As best illustrated in FIGS. 4 and 7, the louver panel 300 mounts to the front end 202 of the housing 200 via connectors 240 and 242, such as mounting bolts, and the bracket 220. The louver panel 300 extends from a base 302 to a cap or top end 304. The base 302 can be referred to alternatively as a bottom end. As illustrated in FIG. 4, the louver panel 300 includes louver modules 310, 330, 350, 370, 390, 410, and 430. The lowermost louver module 310 can be referred to as a base module and it forms and has the base 302. The uppermost louver module 430 can be referred to as a cap module and it forms and has the cap or top end 304.

The cap module 430 includes several holes 470 and 472 through which connectors 240 and 242, respectively, extend. While in this embodiment, the connectors 240 and 242 are mounting bolts, in other embodiments, the connectors 240 and 242 may be any other conventional connectors or fasteners. The connectors 240 and 242 extend through holes 470 and 472, and engage with the openings or holes 230 and 232, respectively, in the housing 200. When the connectors 240 and 242 are tightened in holes 230 and 232, the louver panel 300 is secured to the housing 200.

The base 302 of the louver panel 300 may rest on the bracket 220. The engagement tabs 224 that extend from the bracket 220 engage receiving portions or openings in the base 302, which prevents lateral movement of the lower end of the louver panel 300. The arrangement of the connectors 240 and 242, bracket 220, engagement tabs 224, and the louver panel 300 are discussed in greater detail below with reference to FIGS. 6 and 7.

As mentioned above, the louver modules 310, 330, 350, 370, 390, 410, and 430 are coupled together by two support members or beams 500 and 520 (as best shown in FIGS. 5 and 6) and several connectors. In one embodiment, the beams 500 and 520 are metal strips. The various louver modules that form the louver panel 300 are described in greater detail below.

Turning to FIGS. 5 and 6, the beams 500 and 520 align and support the louver modules that collectively form louver panel 300. Beam 500 includes a main body 502 that has a flange 504 extending substantially perpendicularly from the main body 502 (i.e., 90°+10° from the main body 502 and towards the louver modules) at its lower end, and an opposite upper end 506. Similarly, beam 520 includes a main body 522 that has a flange 524 extending substantially perpendicularly from the main body 522 at its lower end, and an opposite upper end 526.

As best shown in FIGS. 6 and 7, the main body 502 of beam 500 includes several holes 508 arranged along a longitudinal length of beam 500, and flange 504 includes a receiving member 510, such as an opening, on its lower surface (see FIG. 7). Similarly, the main body 522 of beam 520 includes several holes 528 arranged along a length of beam 520, and flange 524 includes a receiving member 530 on its lower surface. The receiving member 530 can be referred to alternatively as an opening. Each of the holes 508 and 528 is configured to receive one of the connectors 512 and 532, respectively, and the receiving members 510 and 530 are configured to receive the engagement tabs 224 extending from the bracket 220 attached to the housing 200.

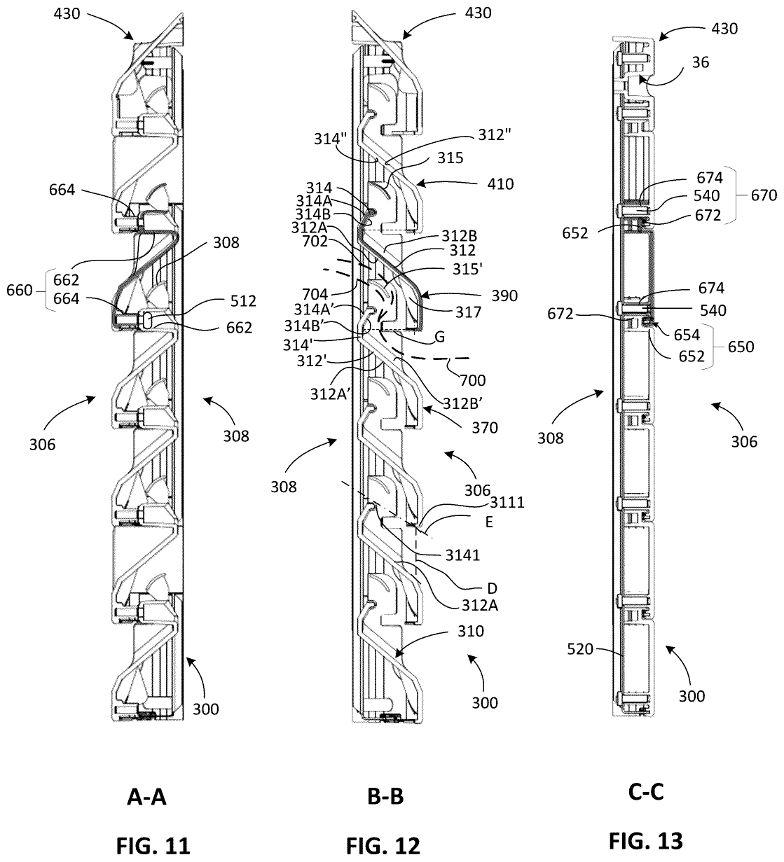

Different sets of connectors couple the louver modules to each other, and the louver modules to the beams 500 and 520. In particular, connectors 512 and 532 extend through the holes 508 and 528 and couple the louver modules to an adjacent louver module and to the beams 500 and 520. Additional connectors 540 (see FIG. 6) couple each module to an adjacent module. The coupling of the beams 500 and 520 and the louver modules are discussed in further detail below with reference to FIGS. 11 and 12.

As noted above, the assembled louver panel 300 mounts to the front end 202 of the housing 200 via the mounting bracket 220 and connectors 240 and 242. Referring to FIG. 7, the mounting bracket 220 supports the base 302, and the tabs 224 extending from the bracket 220 engage the receiving members 510 and 530 in the flanges 504 and 524, respectively. The receiving members 510 and 530 are holes shaped to receive the tabs 224, which cooperate to prevent the base 302 of the louver panel 300 from moving relative to the front end 202 and/or within a horizontal plane perpendicular to the front end 202. Thus, the bracket 220 supports the louver panel 300. In alternative implementations, the tabs 224 may be located on the bracket 220 and the receiving members 510 and 530 may be located on the bracket 220.

In this embodiment, connectors 240 and 242 couple the assembled louver panel 300 to the housing 200. Connectors 240 and 242 are inserted into the holes 470 and 472 in the top louver module 430 and through-holes 514 and 534 (see FIG. 6) in the beams 500 and 520, respectively, to engage the mounting holes 230 and 232 on the front end 202 of the housing 200. The mounting holes 230 and 232 and the connectors 240 and 242 may be threaded to engage each other and to mount the top louver module and the beams 500 and 520 to the housing 200 and prevent the louver panel 300 from moving relative to the housing 200. As noted above, the louver modules are coupled to the beams 500 and 520 to assemble the louver panel 300. Thus, the assembled louver panel 300 is fixed to the housing 200 at the top end 304. Accordingly, the mounting connectors 240 and 242, the bracket 220, and the engagement tabs 224 cooperate to couple the assembled louver panel 300 to the housing 200.

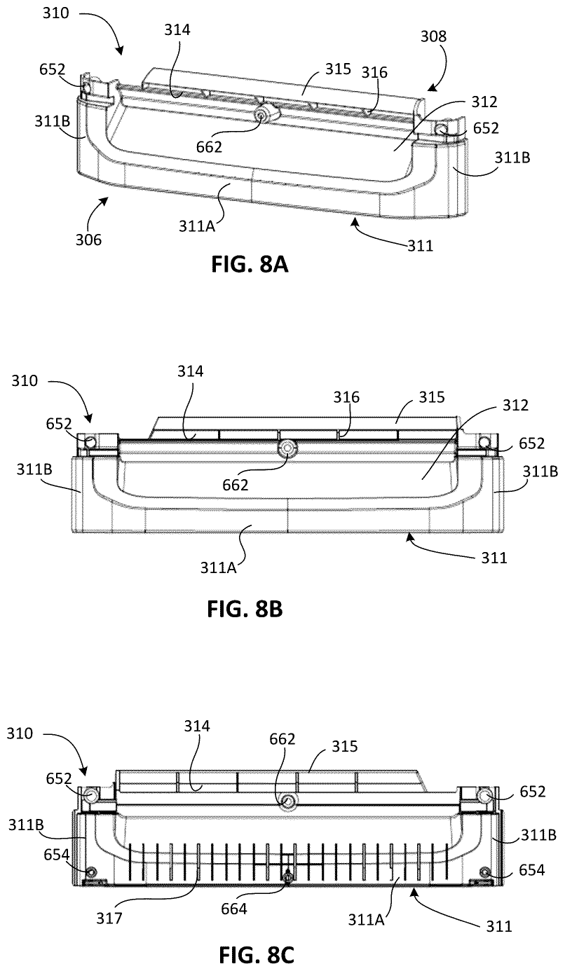

Now various views of the base or bottom louver module 310, the cap or top louver module 430, and an alternate base louver module 450 are illustrated. FIGS. 8A, 9A, and 10A are perspective views of a front side or a downstream side 306 of the base louver module 310, the cap louver module 430 and the alternate base louver module 450, respectively. FIGS. 8B, 9B, and 10B are plan views of the downstream side 306 of the base louver module 310, the cap louver module 430 and the alternate base louver module 450, respectively. FIGS. 8C, 9C, and 10C are plan views of a back side or an upstream side 308 of the base louver module 310, the cap louver module 430 and the alternate base louver module 450, respectively.

Referring to FIGS. 8A-8C, base louver module 310 includes a frame 311, a first fluid guide 312, a second fluid guide 314, and a wing 315. The frame 311 includes a horizontal portion 311A and two vertical portion 311B, with each vertical portion 311B extending vertically from the horizontal portion 311A at each lateral end of the frame 311. Several ribs 317 extend vertically along the upstream side 308 of the frame 311 (see FIG. 8C). The ribs 317 reinforce the frame 311 and may help also guide or rectify a flow of air through the louver panel 300.

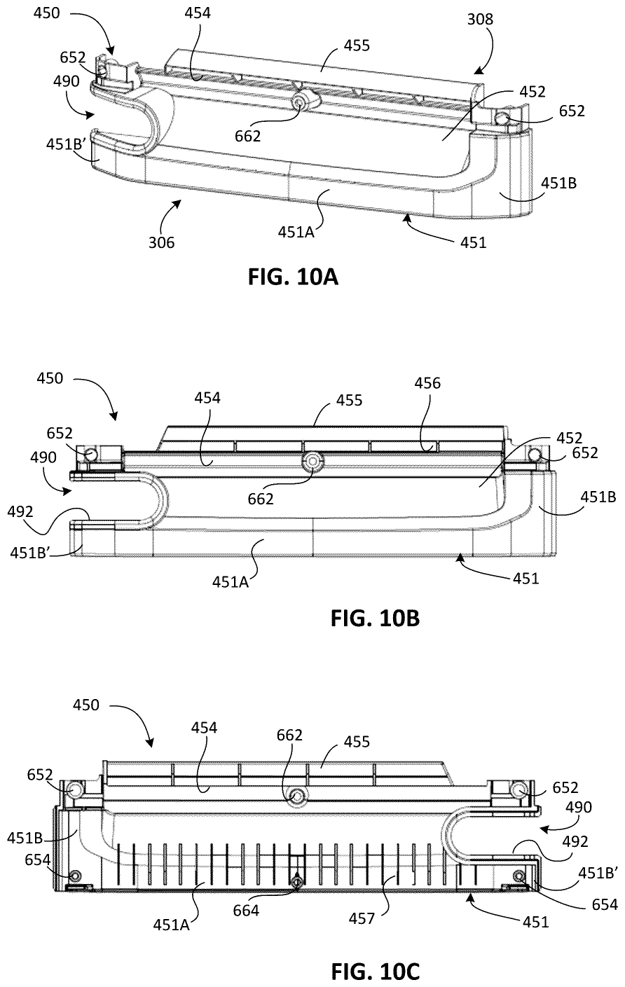

Similarly, as shown in FIG. 10A, alternate base louver module 450 includes a frame 451, a first fluid guide 452, a second fluid guide 454, and a wing 455. The frame 451 includes a horizontal portion 451A and two vertical portions 451B and 451B′, each of which extends vertically from the horizontal portion 451A at each lateral end of the frame 451. Several ribs 457 extend vertically along the upstream side 308 of the frame 451. The ribs 457 reinforce the frame 451 and may help also guide or rectify a flow of air through the louver panel 300. Base louver module 450 includes several struts 456 that are coupled to the second fluid guide 454 and to the wing 455.

Referring back to the lower module 310 shown in FIGS. 8A-8C, the frame 311 supports the first fluid guide 312, the second fluid guide 314 and the wing 315. The first fluid guide 312 extends upward from the horizontal portion 311A of the frame 311 and toward the upstream side 308, and the vertical portions 311B support the opposite lateral sides of the first fluid guide 312. The second fluid guide 314 extends upward from the first fluid guide 312 and curves, or otherwise extends, back towards the downstream side 306. The vertical portions 311B support the opposite lateral sides of the second fluid guide 314 as well.

The wing 315 is located above the first fluid guide 312 and second fluid guide 314. Several struts 316 extend vertically from the second fluid guide 314 and support the wing 315. Additionally, either one or both vertical portions 311B may support a lateral side of the wing 315. That is, the struts 316 are coupled to the second fluid guide 314 and the wing 315, and at least one vertical portion 311B is coupled to a lateral side of the wing 315. The wing 315 may have a curved cross-section (see FIGS. 11 and 12) to help guide and improve the flow of air from the upstream side 308 to the downstream side 306. Additionally, or alternatively, the wing 315 may have an airfoil-shaped cross-section. In some implementations, the wing 315 may be omitted and the flow of air may be guided by the first fluid guide 312 and second fluid guide 314.

Referring to FIGS. 10A-10C, the alternate base louver module 450 is substantially similar to the base louver module 310 except one of the vertical portions, in this case vertical portion 451B′, includes an opening 490 that extends laterally into the louver module 450. The opening 490 provides access through the assembled louver panel 300 to the arc process device 100. For example, the opening 490 may provide access to the front end 202 and/or the air outlet 218 of the housing 200 of the arc process device 100.

The opening 490 is defined by a substantially C-shaped, arcuate wall 492 of the vertical portion 451B′. That is, the arcuate wall 492 extends from a lateral end of the vertical portion 451B′ towards the center of the module 450 and curves upward and back toward the lateral end. Consequently, the vertical portion 451B′ of the frame 451 extends around the opening 490, and thus, the lateral side of the module 450 at the opening 490 has an opening which allows access to the housing 200 through the louver panel 300.

Regardless of the specific geometry of the opening 490, the opening 490 may be sized and shaped for the desired access to the housing 200. For example, the opening 490 may be configured to receive a pluggable module, which would allow it to provide access through the louver panel 300 for connecting a power cable, a control cable, a plug of a cable, and/or other pluggable module to the arc process device 100.

In some implementations, louver module 450 includes openings 490 extending through both vertical portions 451B and 451B′ of the frame 451. Alternatively, the opening 490 may be defined by two or more adjacent louver modules. For example, the arcuate wall may be substantially L-shaped or U-shaped and an opening may be defined at a bottom corner or middle of the frame of one louver module, while an adjacent louver module may include an opening defined by an L-shaped or U-shaped arcuate wall disposed at its top corner or middle. Thus, the two louver modules and their corresponding openings may cooperate to define a larger collective opening to provide desired access to the housing 200 through the louver panel 300.

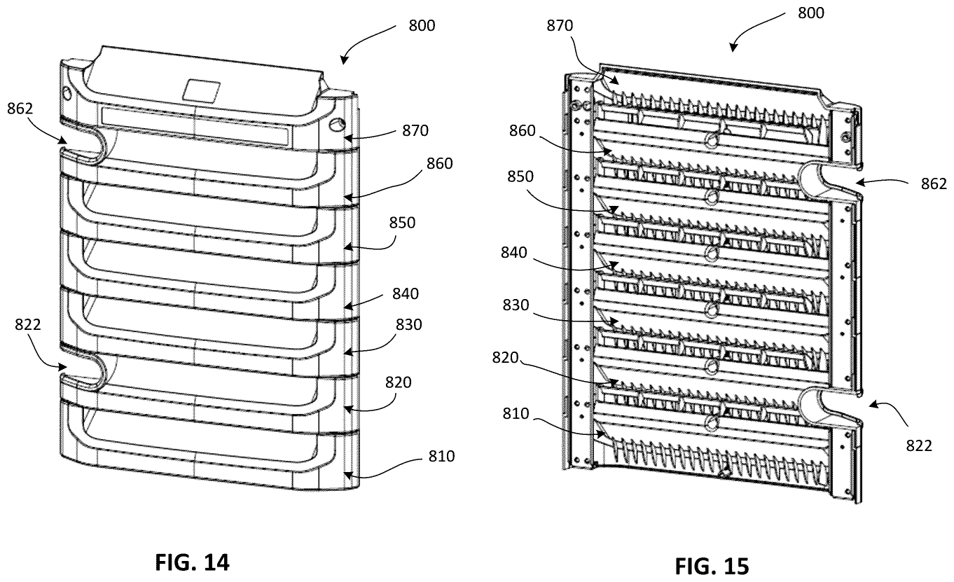

Referring to FIGS. 14 and 15, front and rear perspective views of an alternative embodiment of a louver panel is illustrated. In this embodiment, louver panel 800 has several different louver modules that include two different types of louver modules. As shown, one type of louver module includes louver modules 810, 830, 840, 850, and 870. The other type of louver module includes an opening formed in its vertical portion. In this example, louver modules 820 and 860 include such openings 822 and 862, respectively. By including openings 822 and 862, the housing 200 may be accessed through the louver panel 800 in two different locations.

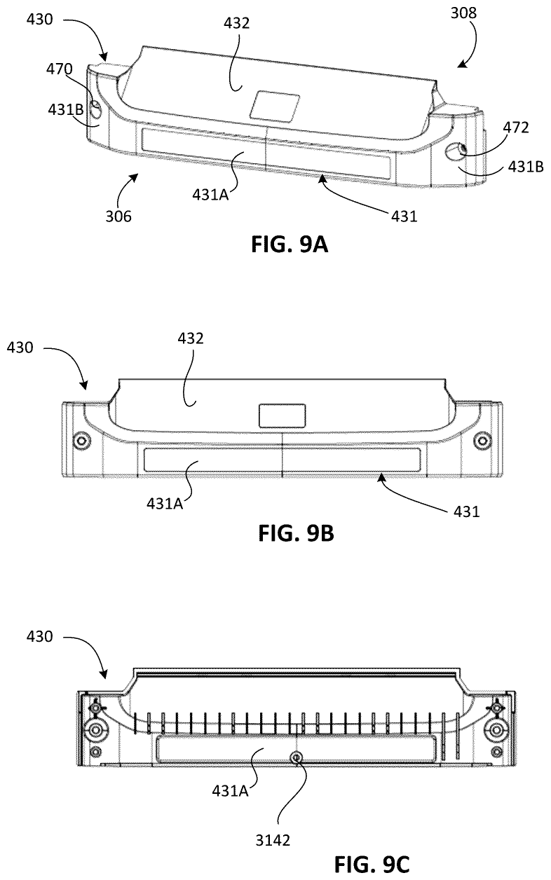

Returning back to FIGS. 9A-9C, in this embodiment, the cap louver module 430 also includes a frame 431 and a first fluid guide 432, but does not include any of the following features of the previously described modules 310 and 450: a second fluid guide, a wing, struts, or an opening formed therein. The frame 431 includes a horizontal portion 431A with vertical portions 431B located at its opposite ends. The cap louver module 430 is configured to cap or be arranged as the top louver module of the louver modules forming louver panel 300, and to assist in mounting the louver panel 300 to the housing 200. The cap louver module 430 includes holes 470 and 472 in the vertical portions 431B that receive connectors 240 and 242, respectively, that couple the louver panel 300 to the housing 200 (see also FIG. 4). The frame 431 includes a connector 3142 that engages an adjacent louver module when they are placed adjacent to each other.

Now referring to FIGS. 11-13, cross-sectional views of the louver panel 300 taken along lines A-A, B-B, and C-C of FIG. 4, respectively, are illustrated. The louver panel 300 includes several louver modules stacked on and/or overlapped with adjacent louver modules, with the cap louver module 430 located at the top of the louver panel 300. The louver modules are coupled together to form several tortuous paths 700 between a downstream side 306 and an upstream side 308 of the louver panel 300. In one implementation, the louver panel 300 is proximate to the air outlet 218 of the housing 200. Accordingly, the terms “upstream side 308” and “downstream side 306” refer to the flow of air through the louver panel 300. The upstream side 308 is a side of the louver panel 300 adjacent to the air outlet 218 of the housing 200 and the downstream side 306 is a side of the louver panel 300 opposite the upstream side 308 on the outside of the louver panel 300. However, in some implementations, the louver panel 300 may be disposed on an inlet of the housing 200 and the upstream and downstream sides would be reversed.

The louver modules are coupled together by several different types of coupling arrangements. In this embodiment, the types of coupling arrangements include a first coupling arrangement 650, a second coupling arrangement 660, and a third coupling arrangement 670. The details of each of the coupling arrangements are described below.

In this embodiment, some of the louver modules include different combinations of coupling arrangements. For example, the cap louver module 430 has a second coupling arrangement 660 and a third coupling arrangement 670, but does not include a first coupling arrangement 650. However, in other implementations, the cap louver module 430 may also include a first coupling arrangement 650. As noted above, the louver modules are coupled together via the beams 500 and 520 and connectors 512 and 532. The third coupling arrangement 670 couples the louver modules and the beams 500 and 520 together.

In this embodiment, the first coupling arrangement 650 involves a connector element located on one louver module that cooperates with a connector element located on another louver module. Referring to FIGS. 8A-8C and FIGS. 10A-10C, each first coupling arrangement 650 includes an upper receiving element 652 formed in the vertical portion of a frame of a louver module proximate to its upper end, and a lower engaging element 654 formed in the vertical portion of a frame of a louver module proximate to its upper end. As shown, each of the louver modules 310 and 450 includes upper receiving elements 652 located on opposite sides on the front side of the louver module. Each of the louver modules 310 and 450 includes lower receiving elements 654 located on opposite sides on the back side of the louver module.

When louver modules having the first coupling arrangement components are stacked or placed proximate to each other, the engaging element 654 of a first louver module is inserted into an upper receiving element 652 of an adjacent second louver module that is below the first louver module. For example, the lower engaging element 654 may be a protrusion that extends from the frame towards the upstream side 308 of the louver module, and the upper receiving element 652 may be a groove or opening disposed in the frame on the downstream side 306 of the louver module.

The lower engaging element 654 of a first louver module engages the upper receiving element 652 of an adjacent second louver module with an interference or snap fit. Meanwhile, the upper receiving element 652 of the first louver module receives the lower engaging element 654 of an adjacent third louver module that is located above the first louver module. The first coupling arrangement 650 of each base louver module may align and temporarily fix the louver modules together. In some alternative implementations, the first coupling arrangement 650 may not fix the louver modules together, but instead may align the louver modules before they are coupled together via the second coupling arrangement 660 and/or the third coupling arrangement 670.

After the first coupling arrangement 650 aligns and/or couples the louver modules together, the second coupling arrangement 660 and/or the third coupling arrangement 670 may couple the base louver modules 310 and the cap louver module 430 together.

The second coupling arrangement 660 may be arranged along a medial portion of the louver modules 310 and 430. Referring to FIGS. 5, 6, and 11, the second coupling arrangement 660 includes an upper receiving element 662, a lower receiving element 664, and a connector 540. In addition, in FIGS. 8A-8C, the upper receiving element 662 may be a ferrule or shaft extending horizontally from a medial portion of the second fluid guide 314 towards the downstream side 306. The upper receiving element 662 is located on the outer surface of the louver module. The upper receiving element 662 may include a ferrule sized to receive a post of the connector 540. The lower receiving element 664 may be a ferrule defining threaded blind hole located at a medial portion the frame 311 and extending towards the upstream side 308. The threaded blind hole is configured to receive the connector 540. The connector 540 couples the lower receiving element 664 of one louver module with an upper receiving element 662 of an adjacent lower louver module. That is, the post of the connector 540 may engage the lower receiving element 664 while a head of the connector 540 may engage a shoulder of the upper receiving element 662, thereby coupling the lower receiving element 664 to the upper receiving element 662.

In particular, the lower receiving element 664 of a first louver module is axially aligned with an upper receiving element 662 of a second louver module that is adjacent to and below the first louver module. Meanwhile, the upper receiving element 662 of the first louver module is axially aligned with a lower receiving element 664 of a third louver module that is adjacent to and located above the first louver module. Once the second coupling arrangement 660 is aligned (i.e., each upper receiving element 662 is coaxial with a corresponding lower receiving element 664 on a different louver module), the connectors 540 are inserted to engage the upper receiving elements 662 and the lower receiving elements 664 to couple adjacent louver modules together. In alternative implementations, the second coupling arrangement 660 may have an engagement portion (e.g., post, tongue, protrusion, etc.) that engages a receiving portion (e.g., hole, groove, slot, etc.) with a snap fit, dovetail, interference fit, or other engagement means, and the connectors 540 may be omitted.

As best illustrated in FIGS. 6 and 13, the third coupling arrangement 670 couples two adjacent modules to the beams 500 and 520. The third coupling arrangement 670 includes an upper ferrule 672 and a lower ferrule 674 configured to receive a connector 512 or 532. The third coupling arrangement 670 is located on each side of a frame of each louver module and aligned with each beam 500 or 520. That is, each third coupling arrangement 670 is configured to align with a corresponding through-hole 514 or 534 of beams 500 or 520, respectively. The upper ferrule 672 is located in the vertical portion 311B of the frame 311 of the louver module 310, and the lower ferrule 674 extends from the frame 311 towards the upstream side 308. The lower ferrule 674 of a first louver module is configured to extend into an upper ferrule 672 of a second louver module that is adjacent to and below the first louver module. That is, the upper ferrule 672 of the adjacent second louver module is configured to receive the lower ferrule 674 of the first louver module. Meanwhile, the upper ferrule 672 of the first louver module is configured to receive a lower ferrule 674 of a third louver module that is adjacent to and above the first louver module.

Each lower ferrule 674 may include a threaded interior surface for receiving one of the connectors 512 or 532. The connectors 512 and 532 may couple the beams 500 and 520 and the various louver modules together. Each connector 512 or 532 extends through one of the through-hole 514 or 534 of the beam 500 or 520, through a corresponding upper ferrule 672 and a corresponding lower ferrule 674, and engage the threads of the corresponding lower ferrule 674 to couple each louver module and each beam 500 and 520 together. In some instances, the connectors 512 and 532, having threads, of the third coupling arrangement 670 may be replaced with an engagement plug or other engagement device that couples to lower ferrules 674 via an interference fit, or snap fit. Accordingly, the third coupling arrangement 670 may include any mechanism for fixing the louver modules and support members together.

As noted above, the first coupling arrangement 650, the second coupling arrangement 660, and the third coupling arrangement 670 may include other types of fixing mechanisms. In alternative embodiments, one or more of the first coupling arrangement 650, the second coupling arrangement 660, and the third coupling arrangement 670 may be omitted. In one example, the louver modules may be coupled together using only the third coupling arrangements 670.

Regardless of how the louver modules are assembled and mounted to the housing 200, the assembled louver panel 300 prevents contaminants from entering the housing 200 and allows cooling air to flow from an upstream side 308 to a downstream side 306. As illustrated in FIG. 12, the louver modules overlap to define several tortuous paths 700 between the upstream side 308 and the downstream side 306. The horizontal portion 311A of the frame 311 and a portion of the second fluid guide 314 the first fluid guide 312 of the base louver module 390 horizontally overlap with at least a portion of the second fluid guide 314′ and/or the wing 315′ of the lower adjacent louver module 370. Similarly, the wing 315 and at least a portion of the second fluid guide 314 of the louver module 390 horizontally overlaps with the horizontal portion 311A of the frame 311 of the upper adjacent louver module 410 and at least a portion of the first fluid guide 312″. Thus, there is no straight line path through the louver panel 300 between the downstream side 306 and the upstream side 308 for a contaminant to pass through. However, cooling air is free to flow from the upstream side 308 to the downstream side 306 via the plurality of tortuous paths 700 between the plurality of louver modules. In some implementations, the frame of a louver module overlaps with at least a portion of the first fluid guide to further define a tortuous path 700.

In particular, a flow of cooling air flows along a tortuous path 700 between each louver module, such as louver module 390, and adjacent louver modules, such as louver modules 370 and 410. The first fluid guide, the second fluid guide, the wing, and the frame of each louver module guides the cooling air through the tortuous paths 700. Specifically, referring to FIG. 12, each of the first fluid guides 312, 312′ includes an upstream or first surface 312A, 312A′ and a second surface 312B, 312B′, respectively. Each of the second fluid guide 314, 314′ includes an upstream or first surface 314A, 314A′ and a second surface 314B, 314B′. An upstream or first surface 314A′ of the second fluid guide 314′ of the adjacent louver module 370 may guide the flow of cooling fluid towards the first louver module 390. The wing 315′ of the louver module 370 may split the tortuous path 700 of the flow of cooling fluid into an upper path 702 and a lower path 704. The wing 315′ may also rectify the flow of air between the modules 370 and 390 and reduce pressure losses between the upstream side 308 and the downstream side 306 of the louver panel 300.

An upstream or first surface 312A of the first fluid guide 312 guides the flow cooling air towards a horizontally extending gap G between the frame 311 and the second fluid guide 314′ of the adjacent louver module 390. Additionally, the ribs 317 of the frame 311 may further rectify and/or guide the flow of cooling air as it flows towards the gap G and to the downstream side 306 of the louver panel 300. Consequently, the airflow between the overlapping modules 370, 390, and 410 may be improved as compared to louver panels without a wing and/or any ribs. For clarity, FIG. 12 illustrates only one tortuous path 700 between louver module 390 and the adjacent louver module 370. However, it is to be understood that the louver panel 300 includes a tortuous path 700 defined by each pair of adjacent louver modules in the louver panel 300.

While the louver panel 300 and louver modules allow for the flow of cooling air to pass from the upstream side 308 to the downstream side 306, the tortuous paths 700 prevent contaminants from passing from the downstream side 306 to the upstream side 308 and into the housing 200. As illustrated in FIG. 12, the first fluid guide 312 and the second fluid guide 314 create solid barriers to contaminants. The first fluid guide 312 extends from the horizontal portion 311A of the frame 311 to the second fluid guide 314 at an angle that is neither perpendicular to nor parallel with a horizontal axis or a vertical axis of the louver panel 300. In some implementations, the angle may be about 45°+15°. Additionally, the second fluid guide 314 extends upward, or substantially vertically (e.g., 90°+) 10°, from an upstream side 308 of the first fluid guide 312 and curves, or otherwise extends, towards the downstream side 306 to further inhibit any contaminants from entering the upstream side 308.

In fact, the curve of the second fluid guide 314 is configured to block any contaminants that may enter the louver panel 300 at an upward angle. Specifically, a downstream end 3141 of the second fluid guide 314 overlaps with horizontal portion 311A of the frame 311 of an adjacent louver module. A height of second fluid guide 314 may be equal to an inlet gap D. In fact, a line E extending between the downstream end 3141 of the second fluid guide 314 and a bottom edge 3111 of the frame 311 may substantially parallel with the second surface 312B of the first fluid guide 312.

Accordingly, the second fluid guide 314 of the louver module 390 overlaps horizontally with the frame 311 of the upper adjacent louver module 410 and the frame 311 horizontally overlaps with the second fluid guide 314′ of the lower adjacent louver module 370. Therefore, there are no substantially straight line gaps in the louver panel 300 between the downstream side 306 and the upstream side 308. That is, contaminants traveling along a partially horizontal trajectory are blocked by the first fluid guide 312 and/or second fluid guide 314 of the louver modules and cannot pass through the louver panel 300. The term “partially horizontal” as defined herein comprises 0°+60° with respect to a horizontal axis that is perpendicular to a longitudinal axis of the louver panel 300 extending from the base to the cap of the louver panel 300. The wings may further prevent contaminants from passing between two adjacent louver modules. Thus, a contaminant entering the louver panel 300 would be blocked by the first fluid guide 312, the second fluid guide 314, and/or the wing 315. Consequently, the overlapping louver modules define tortuous paths 700 and prevent contaminants from passing through the louver panel 300 with a substantially horizontal trajectory.

Moreover, the first fluid guide 312 and the second fluid guide 314 are arranged to prevent passage of any contaminants that may deflect, ricochet, and/or otherwise bounce off of a second surface 312B of the first fluid guide 312, and/or another surface downstream of the louver panel 300, to the upstream side 308 of the louver panel 300. For example, a contaminant may be traveling towards the louver module, contact the second surface 312B of the first fluid guide 312, and bounce up and toward the upstream side 308, similar to the spray 16 illustrated in FIG. 2. However, unlike spray 16, a second surface 314B of the second fluid guide 314 blocks the contaminant from traveling further towards the upstream side 308 regardless of the trajectory of the contaminant before or after contacting the second surface 314B. That is, the first fluid guide 312 and second fluid guide 314 are sized, shaped, angled, and arranged to define the tortuous path 700 to prevent contaminants from entering the upstream side 308 of the louver panel 300 while allowing a flow of cooling fluid to flow from the upstream side 308 to the downstream side 306 along the tortuous path 700. As noted above, the first fluid guide 312 and the second fluid guide 314 are sized and shaped to substantially overlap with an adjacent louver module and prevent almost all straight line trajectories between the downstream side 306 and the upstream side 308. Any contaminants blocked by the louver modules may fall back towards the downstream side 306 and out of the louver panel 300.

While some extreme trajectories, (e.g., trajectories greater than 60 degrees from the horizontal axis in a direction from the downstream side towards the upstream side) may provide a small, straight line gap through the louver panel 300, contaminants with such extreme trajectories are generally unlikely to occur naturally and/or would likely not have enough momentum to pass through the louver panel 300. Moreover, at least a portion of the frame, the first fluid guide, the second fluid guide, and/or the wing of a louver module would likely contact at least a portion of contaminants traveling along such extreme trajectories, thereby deflecting and preventing passage through the louver panel 300.

Accordingly, the techniques presented herein provide a louver panel that guides a flow of a cooling air, while preventing contaminants from passing through the plurality of louver modules. Additionally, the louver panel may be customized for a particular outlet or inlet of a housing by selecting a quantity of louver modules to meet a desired inlet/outlet size, and/or including a type of base louver module to provide access through the louver panel to a side of the housing (e.g., for receiving a pluggable module). Further, the louver panel may be modified by adding, removing, and/or substituting one or more louver modules for a desired inlet/outlet size, and/or to provide access to a side of the housing of the arc process device.

While the invention has been illustrated and described in detail and with reference to specific embodiments thereof, it is nevertheless not intended to be limited to the details shown, since it will be apparent that various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

It is also to be understood that the louver panel described herein, or portions thereof, may be fabricated from any suitable material or combination of materials, such as plastic, foamed plastic, metal, supple natural or synthetic materials including, but not limited to, elastomers, polyester, carbon fiber, resin, plastic, rubber, derivatives thereof, and combinations thereof. Suitable plastics may include high-density polyethylene (HDPE), low-density polyethylene (LDPE), polystyrene, acrylonitrile butadiene styrene (ABS), polycarbonate, polyethylene terephthalate (PET), polypropylene, ethylene-vinyl acetate (EVA), or the like. Suitable foamed plastics may include expanded or extruded polystyrene, expanded or extruded polypropylene, EVA foam, derivatives thereof, and combinations thereof.

Reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions and/or other characteristics (e.g., time, pressure, temperature, distance, etc.) of an element, operations, conditions, etc., the phrase “between X and Y” represents a range that includes X and Y.

For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present invention to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment.

Further, the present disclosure may repeat reference numerals and/or letters in the various examples. This repetition is for the purpose of simplicity and clarity and does not in itself dictate a relationship between the various embodiments and/or configurations discussed.

Similarly, when used herein, the term “comprises” and its derivations (such as “comprising,” etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially”.

As used herein, unless expressly stated to the contrary, use of the phrase “at least one of,” “one or more of,” “and/or,” variations thereof, or the like are open-ended expressions that are both conjunctive and disjunctive in operation for any and all possible combination of the associated listed items. For example, each of the expressions “at least one of X, Y and Z,” “at least one of X, Y or Z,” “one or more of X, Y and Z,” “one or more of X, Y or Z” and “X, Y and/or Z” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms “first,” “second,” “third,” etc., are intended to distinguish the particular nouns they modify (e.g., element, condition, node, outlet, inlet, valve, module, activity, operation, etc.). Unless expressly stated to the contrary, the use of these terms is not intended to indicate any type of order, rank, importance, temporal sequence, or hierarchy of the modified noun. For example, “first X” and “second X” are intended to designate two “X” elements that are not necessarily limited by any order, rank, importance, temporal sequence, or hierarchy of the two elements. Further as referred to herein, “at least one of” and “one or more of” can be represented using the “(s)” nomenclature (e.g., one or more element(s)).

What is claimed is:

1. A louver module, comprising:
a frame;
a first fluid guide supported by the frame; and
a second fluid guide extending from the first fluid guide, wherein the first fluid guide and the second fluid guide cooperate to form a tortuous path from an upstream end of the louver module to a downstream end of the louver module.

2. The louver module of claim 1, wherein the tortuous path permits a flow of gas, and impedes a flow of contaminants.

3. The louver module of claim 1, wherein the first fluid guide extends from the frame at a first angle and the second fluid guide extends from the first fluid guide at a second angle, the second fluid guide is configured to horizontally overlap with a frame of an adjacent louver module, and the second fluid guide obstructs contaminants.

4. The louver module of claim 1, further comprising:
a wing disposed above the first fluid guide and the second fluid guide, wherein the wing is configured to guide a gas from the second fluid guide towards the downstream end of the louver module.

5. The louver module of claim 1, further comprising:
a coupling arrangement configured to couple the louver module to a second louver module.

6. The louver module of claim 5, wherein the coupling arrangement is disposed on the frame and is configured to couple to a second fluid guide of the second louver module.

7. A louvered panel of an arc process device comprising:
a plurality of louver modules defining a tortuous path from an upstream side to a downstream side of the louvered panel, wherein the tortuous path permits a flow of gas, and prevents contaminants from traveling to the upstream side; and
a support member coupled to the plurality of louver modules.

8. The louvered panel of claim 7, wherein the plurality of louver modules are vertically stacked.

9. The louvered panel of claim 7, wherein each louver module of the plurality of louver modules overlaps at least a portion of an adjacent louver module to define the tortuous path.

10. The louvered panel of claim 7, wherein the plurality of louver modules comprises a base module and a cap module.

11. The louvered panel of claim 10, wherein each louver module comprises a frame and a first fluid guide supported by the frame, and the base module further comprises a second fluid guide supported by the frame and extending from the first fluid guide.

12. The louvered panel of claim 11, wherein the base module further comprises a wing disposed above the second fluid guide, the wing configured to guide the flow of gas towards a downstream end of the louvered panel.

13. The louvered panel of claim 11, wherein each frame of each louver module includes at least one coupling arrangement configured to couple to an adjacent frame of an adjacent louver module and the support member.

14. The louvered panel of claim 11, wherein the frame of each louver module overlaps with a second fluid guide of an adjacent louver module, and the frame of each louver module is disposed downstream of a second fluid guide of the adjacent louver module.

15. The louvered panel of claim 7, wherein the support member is a metal strip with a plurality of through-holes configured to receive a plurality of bolts, the plurality of bolts configured to couple the metal strip to the plurality of louver modules.

16. A method of blocking contaminants from entering a housing comprising:
stacking and fastening a plurality of louver modules along a support member to form a louvered panel, the louvered panel defining a tortuous path; and
fastening the louvered panel to an opening of the housing via a fastener;
wherein the tortuous path prevents contaminants from entering the opening while allowing a flow of air through the louvered panel.

17. The method of claim 16, wherein fastening the louvered panel to the opening of the housing further comprises receiving, via the support member, a tab extending from a power supply base.

18. The method of claim 16, wherein the tortuous path is defined by a first fluid guide and a second fluid guide of a first louver module of the plurality of louver modules, and the second fluid guide overlaps with at least a portion of a second louver module.

19. The method of claim 18, wherein the second fluid guide blocks contaminants from entering the opening.

20. The method of claim 18, wherein the portion of the second louver module comprises at least a portion of a frame of the second louver module.
